(19) United States
(12) Patent Application Publication
(10) Pub. No.: US 2011/0154764 A1
(43) Pub. Date: Jun. 30, 2011

(54) COMPOSITE STRUCTURE FOR EXTERIOR INSULATION APPLICATIONS

(75) Inventors: XiaoMing Simon Wang, Shanghai (CN); Hari Parvatareddy, Shanghai (CN); WuLong Hunter Xu, Beijing (CN); Jing Jeffery Li, Shanghai (CN)

(73) Assignee: CAmtek Ltd., Migdal-Haemek (IL)

(21) Appl. No.: 13/060,409

(22) PCT Filed: Sep. 22, 2008
(86) PCT No.: PCT/CN08/01638

§ 371 Date: Feb. 23, 2011

(51) Int. Cl. E04C 2/20; B32B 27/06

(52) U.S. Cl. 52/309.1; 428/507; 428/448; 428/483; 428/430

(57) ABSTRACT

A composite structure comprising an extruded polystyrene layer, a mortar layer and a primer layer, wherein at least one surface of the extruded polystyrene layer is planed, and the mortar layer is made from a mortar composition comprising re-dispersible powder, cellulose ether, one or more viscosity modification agents, one or more hydraulic binders, and one or more aggregates. A method of making such a composite structure.

### BACKGROUND OF THE INVENTION

1. Field of the Invention

The present invention relates to exterior thermal insulation system in the construction industry. Particularly, the present invention relates to a composite structure used in thermal insulation system, which exhibits one or more of the following properties: low water absorption, longer open time, higher bonding strength.

2. Discussion of Background Information

External Insulation Finish System (EIFS), which were developed in Europe in the early 1970s, are an important application in energy saving in building industries. When the first oil crisis happened in early 1970s, countries in Europe began to seriously develop and implement energy saving technologies. For example, in Germany, government provided economic compensation for private house owners to encourage them to apply EIFS in their homes. This policy significantly promoted the development of EIFS. From 1973 to 1993, EIFS was applied in new buildings accounting for about 300 million m² of wall space in Germany alone, thereby saving a significant amount of heating oil during the winter seasons.

In the mid 1980s, some foreign enterprises started to introduce EIFS technology in China. In early 1990s, Ministry of Construction as well as several Chinese provinces strengthened promotion of EIFS, and some scientific research units and enterprises also developed various EIFS technologies at that time. In 1996, the first national energy-saving working conference was held, which further strengthened EIFS technologies from a China perspective. At present, EIFS market in China is rapidly increasing and EIFS is becoming a very important energy saving technology in China.

The function of EIFS is to keep more stable indoor temperature and humidity during climatic conditions transition, thus comfort in residence is considerably improved. Energy is saved through the application of insulation materials in this system. In addition, the reductions in temperature shift and moisture condensation of external wall reduce aging and damage of the buildings.

EIFS mainly has following components: insulation board, adhesive (adhering insulation board to the wall), basecoat mortar (protective coat of insulation board and base coat of finish material) and finish material (painting, tile and stucco, etc.). In the 1970s, EIFS adhesive or basecoat mortar was made from mixing liquid emulsion adhesive into cement on construction site, which was later developed to be two-component formulation used by the industry currently. Many problems occurred with this application method, for example, cement and emulsion could not be mixed uniformly on site, emulsion content could not be well controlled, etc which resulted in poor performance and system failure. In order to overcome these and other problems, increasingly improved technologies based on polymer modified cement-based dry-mixing mortar are becoming more and more popular with EIFS. The product using this technology is becoming the leading product within the Chinese building & construction industry.

Compared with mortar of two-component formulation, dry-mixing mortar (also known as one-component formulation) has the following advantages:

1. High product quality; premixing mortar from automation production in large scale is stable and reliable in quality, and a great number of additives are able to meet special quality requirements;

2. High production efficiency;

3. Convenient for transport and storage; and

4. Reduction of on-site mixing noise, powder and polluted; loss and waste of raw materials are lower.

Generally speaking, adhesive mortar of EIFS should have the following characteristics:
High bonding performance
Low shrinkage
Perfect water retention and uniformity, good workability
Water proof and alkali proof

Basecoat mortar of EIFS should also have the following properties:
Sufficient deformation ability
Compatibility with finish material
Freeze-thaw resistance
Quick drying, early strength and high construction efficiency
Excellent anti-impact performance

Dry-mixing mortar product generally has three main components: adhesive material, aggregate (including fine filler) and various chemical admixtures. Adhesive material mainly refers to inorganic binding material such as cement, lime and gypsum, etc. It plays an important role in the final strength of dry-mixing mortar. Aggregate in dry-mixing mortar refers to inorganic material without binding function. It includes coarse aggregate and fine filler. The particle size of coarse aggregate is large with maximum size up to 8 mm. The particle size of fine filler is small, generally less than 0.1 mm. The aggregate of most dry-mixing mortar is quartz sand which usage level is high. The fine filler may be calcium carbonate powder.

EIFS technology relates to the use of expanded polystyrene board (“EPS”) to insulate building external wall. A typical EIFS schematic is shown in FIG. 1. In a typical application, bonding strength of adhesive mortar or rendering-coat mortar to EPS board is about 0.1 Mpa, and the open time of those mortars is about 1.5 hr.

Problems now existing include:

Typical polymer mortar's pot-life (open time) is about 1.5 hour, and in weather temperature, such open time may be less than 1.5 hour. which is not user-friendly and with negative effect to installation quality on a job-site

Bonding strength of polymer mortar to insulation is about 0.1 MPa, which is considered low, especially for tile finish application.

Existing water absorption requirement of polymer mortar layer is less than 500 g/m2, which is considered high, and with negative impact to system durability (freeze/thaw performance, anti-weathering performance).

One aspect of the present invention seeks to develop a new composite structure with mortar composition having longer open time, better bonding strength and better water absorption of the system.

### SUMMARY OF THE PRESENT INVENTION

The present invention relates to a composite structure comprising an extruded polystyrene layer, a mortar layer and a primer layer, wherein at least one surface of the extruded polystyrene layer is planed, and the mortar layer is made from a mortar composition comprising: a) re-dispersible powder, b) cellulose ether, c) one or more viscosity modification agents, d) one or more hydraulic binders, and e) one or more aggregates.

In one embodiment, the extruded polystyrene layer is a foam thermal insulation board. In a preferred embodiment, the mortar layer is adjacent to the extruded polystyrene layer. In another embodiment of the present invention, the composite structure further comprises a finish layer, wherein the mortar layer is applied between the extruded polystyrene layer and the finish layer. In yet another embodiment, the primer layer is applied to the planed surface of the extruded polystyrene layer. In another embodiment, the primer layer is applied between the extruded polystyrene layer and the mortar layer.

In one embodiment of the present invention, the re-dispersible powder comprises spray drying powder of emulsion latex, preferably, the re-dispersible powder comprises an ethylene containing polymer. More preferably, the re-dispersible powder comprises vinyl ester-ethylene copolymer. Even more preferably, the re-dispersible powder comprises at least one of vinyl acetate-ethylene copolymer, vinylacetate/vinyl-versatate copolymer, styrene-butadiene copolymer, styrene-butadiene copolymer, and styrene/acrylic copolymer or a mixture thereof. Most preferably, the re-dispersible powder comprises vinyl acetate-ethylene copolymer.

In one embodiment, the composite structure includes a mortar composition having about 0.1 wt. % to about 20 wt. %, preferably about 1 wt. % to about 10 wt. %, more preferably about 2 wt. % to about 5 wt. % of the re-dispersible powder.

In another embodiment, the cellulose ether comprises hydroxypropyl methyl cellulose ether. The mortar composition comprises about 0.01 wt. % to about 50 wt. %, preferably about 0.1 wt. % to about 10 wt. % of the cellulose ether.

In yet another embodiment, the viscosity modification agent comprises a member of smectitie group of minerals, preferably comprises hectorite clay and more preferably comprises unmodified hectorite clay. The mortar composition comprises about 0.01 wt. % to about 1 wt. %, preferably about 0.05 wt. % to about 0.5 wt. %, more preferably about 0.1 wt. % to about 0.3 wt. % of the viscosity modification agent.

In one embodiment, the hydraulic binder comprises cement. The mortar composition comprises about 10 wt. % to about 80 wt. %, preferably about 20 wt. % to about 40 wt. %, more preferably about 25 wt. % to about 35 wt. % of the hydraulic binder.

In another embodiment, the aggregate comprises quartz sand. The mortar composition comprises about 20 wt. % to about 80 wt. %, preferably about 30 wt. % to about 70 wt. %, more preferably about 50 wt. % to about 65 wt. % of the aggregate.

In one embodiment, the primer composition is water-dispersible. The primer composition preferably comprises emulsion polymer, more preferably comprises polyacrylic emulsion.

In another embodiment, the primer composition is applied in an amount of about 2.5 g/m² to about 150 g/m² with each surface of the extruded polystyrene layer. In a preferred embodiment, the primer composition is applied in an amount of about 5 g/m² to about 50 g/m² with each surface of the extruded polystyrene layer. In a more preferred embodiment, the primer composition is applied in an amount of about 20 g/m² to about 35 g/m² with each surface of the extruded polystyrene layer.

In one embodiment, the mortar composition is applied to the extruded polystyrene layer to form incontinual or discontinuous mortar layer. In another embodiment, the mortar composition is applied to the extruded polystyrene layer to form a uniformed and continuous layer.

The present invention also relates to a composite structure comprising an extruded polystyrene layer, a mortar layer and a primer layer, wherein at least one surface of the extruded polystyrene layer is planed; and the mortar layer is adhered to the extruded polystyrene layer with a bonding strength higher than 0.2 MPa. In a preferred embodiment, the mortar layer is adhered to the extruded polystyrene layer with a bonding strength higher than 0.25 MPa

The present invention also relates to a composite structure comprising an extruded polystyrene layer, a mortar layer and a polyacrylic emulsion layer, wherein both surfaces of the extruded polystyrene layer are planed, upon which the polyacrylic emulsion layers are applied, the mortar layer is further applied on the polyacrylic emulsion layers; and the mortar layer is made from a mortar composition comprising: about 2 wt % to about 5 wt % of vinyl ester-ethylene copolymer powder, about 0.1 wt % to about 1 wt % of hydroxypropyl methyl cellulose ether, about 0.1 wt. % to about 0.3 wt. % of unmodified hectorite clay, about 25 wt % to about 35 wt % of cement, and about 50 wt % to about 65 wt % of quartz sand.

In a preferred embodiment, at least one mortar layer comprises embedded fiber glass mesh.

In another embodiment of the present invention, the mortar layer has a thickness of about 2 mm to about 10 mm and the extruded polystyrene layer has a thickness of about 2 cm to about 15 cm,

The present invention also relates to an exterior thermal insulation system for attachment to wall substrate comprising: leveling screed; stucco finish layer; and a composite structure wherein the mortar layer is used between a thermal insulation layer and the leveling screed.

In one embodiment, the primer layer is applied on both surfaces of the insulation layer.

The present invention also relates to a mortar composition having an open time of more than 2.0 hours, a bonding strength of more than 0.25 Mpa with thermal insulation board, and water absorption of lower than 390 g/m².

The present invention also relates to a method for insulating and finishing an exterior of a building structure comprising: applying a mortar composition onto a leveled substrate to form a mortar layer; preparing planned surface of an extruded polystyrene foam insulation layer; applying a primer composition onto the planned surface of the extruded polystyrene layer to form a primer layer; and applying an insulation layer onto the mortar layer, wherein the mortar composition is made from a mixture comprising: re-dispersible powder, cellulose ether, one or more viscosity modification agents, one or more hydraulic binders, and one or more aggregates.

In one embodiment, the method of present invention further comprises applying the primer composition onto the extruded polystyrene foam insulation layer, wherein both surfaces of the extruded polystyrene foam insulation layer are planned; applying a rendering coat mortar composition onto the extruded polystyrene foam insulation layer, and applying a stucco finish or painting onto the rendering coat mortar.

In another embodiment, the present method further comprises fixing a thermal insulation layer onto the adhesive mortar layer by mechanical fixing; and embedding fiber glass mesh onto the rending coat mortar, upon which stucco finish or painting is applied.

In another embodiment, the present method further comprises a composite structure, wherein the mortar composition further comprises an enforcing fiber. In a yet another embodiment, the reinforce fiber is plastic fiber.

### BRIEF DESCRIPTION OF DRAWING

The present invention is further described in the detailed description which follows, in reference to the noted plurality of drawings by way of non-limiting examples of embodiments of the present invention, in which like reference numerals represent similar parts throughout the several views of the drawings, and wherein:

FIG. 1. Illustration of EIFS.

FIG. 2. Illustration of bonding strength test method.

FIG. 3. Schematic diagram of bending strength test method.

FIG. 4. Wall dimension for full-scale weathering test.

FIG. 5. Schematic drawing of a PVC deckle frame for preparing mortar composition applied samples.

FIG. 6. Tensile strength of STYROFOAM* piece at various thicknesses.

FIG. 7. Bonding Strengths of undiluted primer compositions treated STYROFOAM* board to adhesive mortar.

FIG. 8. Bonding Strengths of 1:1 diluted primer compositions treated STYROFOAM* board to adhesive mortar.

FIG. 9. Bonding Strengths of 1:1.5 diluted primer compositions treated STYROFOAM* board to adhesive mortar.

FIG. 10. Bonding Strengths of R161N treated STYROFOAM* board.

FIG. 11. Dry bonding strength among three RDP. The samples were cured for 14 days at 23° C. and 50% humidity

FIG. 12. Wet bonding strength among three RDP. The samples were cured for 14 days at 23° C. and 50% humidity followed by immersed in water for 7 days

FIG. 13. High temperature bonding strength among three RDP. The samples were cured for 7 days at 23° C. and 50% humidity followed by cured for 7 days at 50° C.

FIG. 14. Hydration rates of mortar compositions with different CE.

FIG. 15 Dry bonding strength comparison between two CE at two DLP % levels. The samples were cured for 14 days at 23° C. and 50% humidity

FIG. 16. Wet bonding strength comparison between two CE at two DLP % levels. The samples were cured for 7 days at 23° C. and 50% humidity followed by immersed in water for 7 days

FIG. 17. High temperature bonding strength comparison between two CE at two DLP % levels. The samples were cured for 7 days at 23° C. and 50% humidity followed by cured for 7 days at 50° C.

FIG. 18. Bonding strengths to concrete at different cement ratios.

FIG. 19. Bonding strengths to STYROFOAM* at different cement ratios.

FIG. 20. Bonding strength comparison of the mortar compositions formulated by two cements.

FIG. 21. Bonding strength comparison of the mortar compositions formulated by two water ratios.

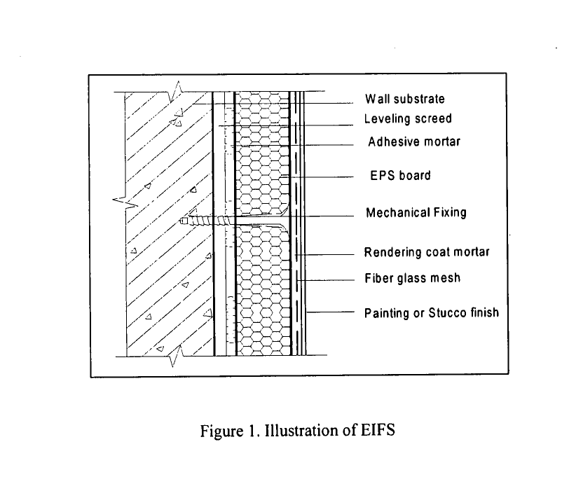

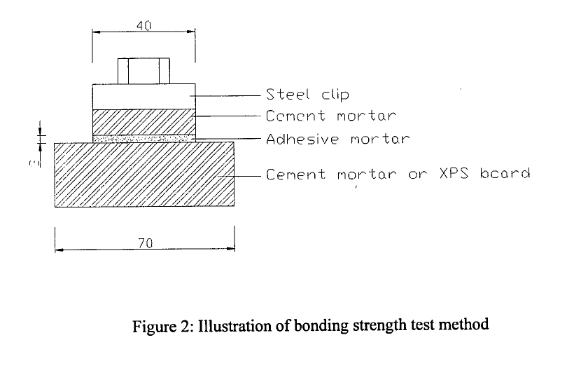

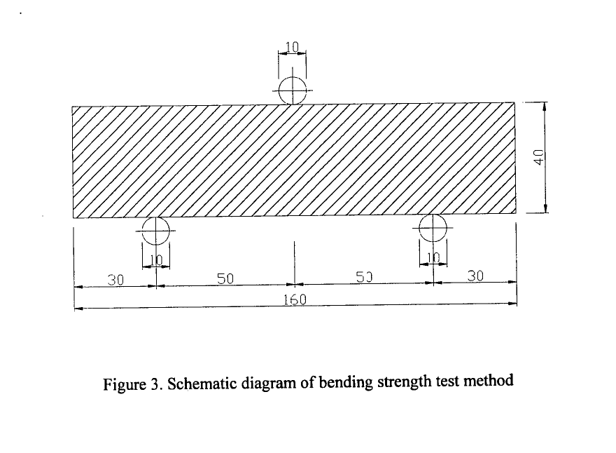

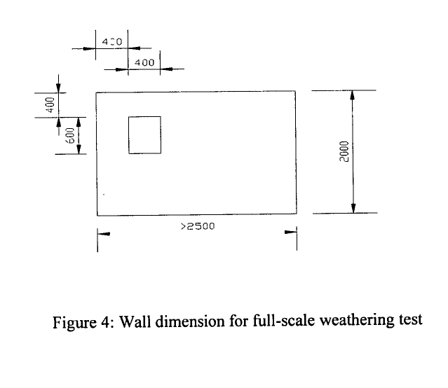

### DETAILED DESCRIPTION OF THE PRESENT INVENTION

In the following detailed description, the specific embodiments of the present invention are described in connection with its preferred embodiments. However, to the extent that the following description is specific to a particular embodiment or a particular use of the present techniques, it is intended to be illustrative only and merely provides a concise description of the exemplary embodiments. Accordingly, the invention is not limited to the specific embodiments described below, but rather; the invention includes all alternatives, modifications, and equivalents falling within the true scope of the appended claims.

As used herein:

Unless otherwise stated, all percentages, %, are by weight based on the total weight of the dry mortar composition. The descriptions of the various ingredients set forth below are non-limiting.

The “exterior insulation finish system (EIFS)” is an exterior wall cladding system, also known as External Thermal Insulation Systems (ETICS) in Europe. It can be used on both residential and commercial buildings for purpose of energy saving, improving room comfort and protecting walls against moisture and other external elements.

The “mortar composition” used in EIFS comprises
re-dispersible powder,
cellulose ether,
one or more viscosity modification agents,
one or more hydraulic binders, and
one or more fillers.

The mortar composition of present invention may further comprise some additives, such as early strength agent, water repellent agent, natural wood cellulose, etc. When mortar composition is applied on any substrate, “mortar layer” will be formed thereon.

Depending on different purposes, mortar composition may be used as a) adhesive mortar which is used to adhere insulation board to wall substrate, and b) rendering coat mortar (base mortar) which is normally used between finish layer and insulation board. The contents of components may differ from each other.

Depending on different components, mortar composition may be classified into “cement mortar” and “polymer mortar.” Cement mortar usually means a mortar composition comprising cement, portland cement, sand/aggregrates, water, and other inorganic additives and fillers such as fly ash etc. Typically, cement mortar does not contain emulsion polymer and other polymer-containing additives. Polymer mortar or polymer modified mortar means a mortar composition comprising cement and other components of cement mortar plus polymer additives such as latex/emulsion polymer. In a typical process, liquid emulsion polymers are added to cement mortar on the construction site to make polymer mortar. However, in one embodiment of the present invention, the polymer mortar is referred to as one-component polymer mortar. Such a unique polymer mortar is a premixed dry composition. It can be pre-prepared even before reaching the construction site by mixing dry mix redispersible polymer powder with cement mortar.

The “extruded polystyrene layer” or “extruded polystyrene board (XPS)” means a polystyrene board prepared by expelling an expandable polymeric foam composition comprising a styrenic polymer and a blowing agent from a die and allowing the composition to expand into a polymeric foam. A styrenic polymer is one is which a majority of the monomer units are styrene or a derivative thereof. This specifically includes copolymers of styrene with acrylonitrile, acrylic acid, acrylate esters and the like. Typically, extrusion occurs from an environment of a pressure sufficiently high so as to preclude foaming to an environment of sufficiently low pressure to allow for foaming. Generally, extruded foam is a continuous, seamless structure of interconnected cells resulting from a single foamable composition expanding into a single extruded foam structure. However, one embodiment of extruded foam includes “strand foam”. Strand foam comprises multiple extruded strands of foam defined by continuous polymer skins with the skins of adjoining foams adhered to one another. Polymer skins in strand foams extend only in the extrusion direction of the strand.

The thickness of XPS varies depending on climate, humility, etc. at construction site. Normally it is about 20 to about 150 mm, or greater.

The “expanded polystyrene layer” or “expand polystyrene board (EPS)” means a foamable composition prepared in an expandable polymer bead process by incorporating a blowing agent into granules of polymer composition (for example, imbibing granules of polymer composition with a blowing agent under pressure). Subsequently, expand the granules in a mold to obtain a foam composition comprising a multitude of expanded foam beads (granules) that adhere to one another to form “bead foam.” Pre-expansion of independent beads is also possible followed by a secondary expansion within a mold. As yet another alternative, expand the beads apart from a mold and then fuse them together thermally or with an adhesive within a mold.

Bead foam has a characteristic continuous network of polymer bead skins that encapsulate collections of foam cells within the foam. Polymer bead skins have a higher density than cell walls within the bead skins. The polymer bead skins extend in multiple directions and connect any foam surface to an opposing foam surface, and generally interconnect all foam surfaces. The polymer bead skins are residual skins from each foam bead that expanded to form the foam. The bead skins coalesce together to form a foam structure comprising multiple expanded foam beads. Bead foams tend to be more friable than extruded foam because they can fracture along the bead skin network. Moreover, the bead skin network provides a continuous thermal short from any one side of the foam to an opposing side, which is undesirable in a thermal insulating material.

Extruded foams are distinct from expanded polymer bead foam by being free from encapsulated collections of beads. While strand foam has a skin similar to bead foam, the skin of strand foam does not fully encapsulate groups of cells but rather forms a tube extending only in the extrusion direction of the foam. Therefore, the polymer skin in strand foam does not extend in all directions and interconnect any foam surface to an opposing surface like the polymer skin in expanded polymer bead foam.

Planed surface of extruded polystyrene layer is the rough surface of the board, which is obtained through peeling off the dense layer of the extruded polystyrene board. Planed surface could also be achieved by other ways, such as abrasion.

The “foam insulation board” or “thermal insulation board” means thermal insulation materials in the form of board. The core of EIFS application is to attach thermal insulation materials to the substrate wall by using an adhesive mortar. The outer surface of EIFS is then covered by fiber mesh embedded base mortar and further completed by other finish materials such as stucco, painting or ceramic tile. The thermal insulation materials can be EPS, XPS, polyurethane foam, mineral wool or even cork boards, all of which can provide thermal insulation to the building as well as meet insulation/energy codes. A mortar layer is normally adjacent to the thermal insulation board and optionally, a primer layer may be applied between them.

The “finish layer” is normally the most outside surface of the composite structure, which could be a painting layer, ceramic tile, or stucco layer.

The “leveling screed” means the final, level, smooth surface of a solid floor or wall onto which the floor or wall covering is applied—usually of mortar layer, or fine concrete.

The “stucco finish” is a type of finishing plaster that is commonly used on the exterior of buildings, and has been used in construction for centuries in various forms. While it can also be used inside, specially designed interior plasters have replaced stucco for interior use in most regions. In ancient times, interior stucco would be made by mixing marble dust, lime, and water to create a smooth plaster which could be molded into elaborate scenes and painted. Spanish, Greek, and Mission style architecture all prominently feature stucco, which helps to reflect heat and keep homes cool.

A variety of materials can be used to make stucco. Traditional stucco uses lime, a material made by baking limestone in kilns so that it calcifies, along with sand and water. These elements are mixed into a paste which can be troweled onto a surface or molded, as used to be common with interior stucco. Stucco made in this fashion is durable, strong, and heavy. Because lime is somewhat soluble, cracks in the stucco will fix themselves, as the lime will drip to fill them if moistened. More commonly today, stucco uses finely ground Portland Cement, sand, and water, which results in a less durable form of stucco that easily cracks.

The “re-dispersible power” (“RDP”) is made by spray drying process from emulsion polymer in the presence of various additives like protective colloid, anti-caking agent and etc. Many types of polymers can be used to produce RDP: ethylene/vinylacetate copolymer (vinyl ester-ethylene copolymer), vinylacetate/vinyl-versatate copolymer (VeoVa), styrene/butadiene copolymer, styrene/acrylic copolymer, and etc. To carry out spray drying, the dispersion of the copolymer, if appropriate together with protective colloids, is sprayed and dried. When mixed with water, these polymer powders can be re-dispersed and to form emulsion, which in turn forms continuous films within cement mortar later while the water is removed by evaporation and hydration of cement. These continuous films serve as “bridges” to bind the mortar layer to the substrate, thus improving the mortar layer's inherent strength and the adhesion to the substrate. Minimum Film Forming Temperature (MFFT) is a term used to describe a minimum temperature requirement at which the films can be formed. Once the films are formed, the benefits from RDP will be gained. MFFT and the Glass Transition Temperature (Tg) of the polymer are two key parameters to define a RDP property. Dow Latex Powders (DLP) is designed for the construction industry, primarily as additives for cement or gypsum based dry blend products.

Preferred vinyl esters comprise vinyl acetate, vinyl propionate, vinyl butyrate, vinyl 2-ethylhexanoate, vinyl laurate, 1-methylvinyl acetate, vinyl pivalate, and vinyl esters of alpha-branched monocarboxylic acids having from 5 to 11 carbon atoms. Some preferred examples include VeoVa5®, VeoVa9®, VeoVa10®, VeoVa11® (Trade names of Shell) or DLP2140 (trade name of Dow). Preferred methacrylic esters or acrylic esters include methyl acrylate, methyl methacrylate, ethyl acrylate, ethyl methacrylate, propyl acrylate, propyl methacrylate, n-butyl acrylate, n-butyl methacrylate, and 2-ethylhexyl acrylate. Preferred vinyl-aromatics include styrene, methylstyrene, and vinyltoluene. A preferred vinyl halide is vinyl chloride. The preferred olefins are ethylene and propylene, and the preferred dienes are 1,3-butadiene and isoprene.

The RDP fraction is preferably from about 0.1 to about 20% by weight, more preferably from about 1 to about 10% by weight, and most preferably from about 2 to 5% by weight.

The “ethylene containing polymer” means a polymer containing the moiety of ethylene, i.e. the structure: —CH₂—CH₂—.

The “emulsion polymer” or “polymer dispersion” means a two phase system having finely dispersed polymeric particles in solvent such as water. An aqueous emulsion polymer is normally composed of polymeric particles, such as vinyl polymer or polyacrylic ester copolymer and a surfactant containing hydrophobic and hydrophilic moieties. The preferred aqueous emulsion polymer when applied as a coating on a substrate and cured at ambient or elevated temperature, has been found to have excellent solvent, chemical and water resistance, exterior durability, impact resistance, abrasion resistance, excellent adhesion to a variety of substrates etc.

A “primer composition” is normally used to adhere surfaces together. The primer composition used in EIFS is also a member of emulsion polymer and normally water-dispersible. One example of primer composition comprises polyacrylic emulsion. Primer composition is brushed onto the surfaces of all kinds of substrates, such as the foam insulation board. A coating (layer) will be formed on the surface after the mortar composition is dried. Sometimes, a primer composition (normally the commercialized product) may be further diluted on construction site by corresponding solvent, normally water.

The primer composition is applied preferably in an amount of about 2.5 g/m² to about 150 g/m², more preferably from about 5 g/m² to about 50 g/m², and most preferably from 20 g/m² to about 35 g/m² of the surface of the extruded polystyrene layer.

The “cellulose ether” (“CE”) is a commonly used additive in dry-mixing mortar composition as a rheology modifier. But it is found that the main benefits brought by CE are improved workability and water retention. Good workability is preferred by the onsite workers; and high water retention can prolong the pot life (open time) before wet mortar composition being used hence the quality of the mortar layer can be maintained for a relative longer time before use. Since CE used in EIFS mortar composition is very limited (<1%), the performance of the whole system is mildly influenced by the CE additive compared with large attributes from RDP. Preferred example of cellulose ether is hydroxylpropyl methyl cellulose ether, such as METHOCEL CP 1425 (Trade name of Dow).

The cellulose ether fraction is preferably from about 0.01 to about 50% by weight, more preferably from about 0.1 to about 10% by weight, and most preferably from about 0.2 to 0.4% by weight.

The “viscosity modification agent” or “thickeners” are used in construction industry to modify the viscosity of the mortar composition. Example of thickeners are polysaccharides such as cellulose ethers and modified cellulose ethers, starch ethers, guar gum, xanthan gum, phyllosilicates, polycarboxylic acids such as polyacrylic acid and the partial esters thereof, optionally acetalized and/or hydrophobically modified polyvinyl alcohols, casein, and associative thickeners. It is also possible to use mixtures of these thickeners. Preference is given to cellulose ethers, modified cellulose ethers, optionally acetalized and/or hydrophobically modified polyvinyl alcohols, and mixtures thereof. The mortar composition preferably contains from 0.05 to 2.5% by weight, more preferably from 0.05 to 0.8% by weight of thickeners.

In construction systems such as mortar composition, renderings, stuccos, flooring systems and building adhesives, flow control is very important. The main additive used to provide thickening and water retention is cellulose ether. However, it is found that the system performance and application behavior can be significantly improved by using one or more rheological agents in combination with cellulose ethers. In general, rheological agents offer the following benefits:
Workability and tooling
Improved sag resistance
Thixotropy
Anti-settling properties
Improved pumpability and shear-thinning
Anti-bleeding

Hectorite clay is a highly efficient mineral rheological additive used to control flow properties in a variety of construction system. Hectorite is a member of the smectitie group of minerals, a family of naturally occurring layered swelling clays. The smectitie clay is layered silicates which can swell in water and are therefore widely used as rheological additives. The silicate platelets have three layers, two silicon dioxide layers embedding a metal oxide layer. The metal oxide layer in hectorite is magnesium. The surfaces of hectorite platelets are negatively charged because the divalent magnesium in hectorite is partly replaced by monovalent lithium, which results a charge deficiency. Preferred example of hectorite clay includes BENTONE OC made by Elementis Specialties Inc. These naturally occurring hectorite clay are sometimes referred to as unmodified hectorite clay.

Hectorite clay sometimes may be combined with other inorganic or organic materials, such as polysaccharide or quarternary ammonium, to make “modified hectorite clay” to alter its rheological curve or get new properties for new application. For example, the organoclays are modified by quarternary ammonium It can then used in solvent borne system due to hydrophobic property.

The viscosity modification agent fraction is preferably from about 0.01 to about 1% by weight, more preferably from about 0.05 to about 0.5% by weight, and most preferably from about 0.1 to 0.3% by weight.

The “hydraulic binder” is widely used in construction industry. The hydraulic binder fraction is preferably from 0.5 to 70% by weight, more preferably, 8 to 50% by weight. Generally, cement or gypsum is used.

The hydraulic binder fraction is preferably from about 10 to about 80% by weight, more preferably from about 20 to about 40% by weight, and most preferably from about 25 to 35% by weight.

Cement typically accounts for the largest portion in a mortar composition. The cement provides adhesive strength to substrate through hydration process in the presence of water. The sufficient hydrated cement has very high mechanical strength as well as water resistance, but the flexibility is very poor. Due to functional requirements in applications such as EIFS, the cement has to be modified by flexible polymers. China is the largest cement producers all over the world, with about 50% of the global production capacity. However, the cements produced in China vary largely in terms of quality and types of different active fillers such as scoria, pozzolana and etc. The cement manufacturers usually modify the ingredients in according to seasonal changes and/or customer requests, as long as the cements still can meet the national standards. The maximum content of active fillers reaches up to 70% sometimes, while in western countries, the inert fillers is typical less than 5% in pure silicate cements, a.k.a. Portland cements.

The cements produced in China are mainly designed as structural load bearing materials in buildings rather than functional components in EIFS, hence it's complex to study their initial strengths, set times and compatibility with additives. For the sake of quality control, it's suggested to use Portland cement in EIFS because the ingredients in the filler-rich cements vary frequently and the interaction between the ingredients and the rest polymeric additives is difficult to control. The relative higher purity in Portland cement reduces the fluctuation of formulations and consequently improves stability of mortar layers. Preference is given to using Portland cement.

“Aggregate” in dry-mixing mortar composition refers to inorganic material without binding function. It includes coarse aggregate and fine filler. The particle size of coarse aggregate is typically large with maximum size up to 8 mm. The particle size of fine filler is typically small, generally less than 0.1 mm. One example of aggregate is quartz sand which usage level is high, while fine filler is mostly calcium carbonate powder.

The aggregate fraction is preferably from about 20 to about 80% by weight, more preferably from about 30 to about 70% by weight, and most preferably from about 50 to 65% by weight.

Quartz sand belongs to raw materials of mine product in silicon. Raw materials of mine product in silicon refer to natural mineral materials with much SiO₂ content, generally including quartz sand, quartz rock, vein quartz, conite and etc. The chemical content of quartz is SiO₂ with vitreous luster, with grease luster at fracture, generally the degree of hardness 7 and density 2.65-2.66 g/cm³.

Quartz sand generally refers to all sorts of sand with quartz content at absolute high level, such as sea sand, fluvial sand and lake sand, etc. In most cases, as an absolutely necessary aggregate of dry-mixing mortar composition, quartz sand has great effect on mortar layer strength, volume stability and water consumption. In addition, the particle size, water content and mud content of quartz sand will directly affect the bonding strength, compressive strength and workability of mortar layer.

Quartz sand in middle and lower course of river is generally round in shape (less for edge angle shape or flaky particle). Quartz sand has little contaminant after long-distance conveying and under-washing. Such fluvial sand is mostly used in dry-mixing mortar composition, and the sand should go through such processes as water scrubbing, drying and screening after being dug out. It was then made into quartz sand aggregate with different grading.

The “fiber glass mesh” is normally made of white and odorless fabric. An example is white C-glass fiber woven fabric, coated with SBR (styrene butadiene latex), with various mesh size (4×4 mm, 5×5 mm, 4×5 mm etc.) and surface weight (135, 145, 160, 200, 300 g/m2 etc.). Used as additional reinforcement fabric embedded in the middle of EIFS basecoat mortar for surface to resist cracking and impact. One roll is sufficient for approx. 45 m² (1 m wide, 50 m long, but 1.1 m2 per m² of surface).

The reinforcing fiber, such as plastic fiber, may also be mixed into the mortar composition to improve performance. One example of the reinforcing fiber is disclosed in U.S. Pat. No. 6,844,065.

In a typical installation process, after the adhesive mortar sets, polish and clean the Styrofoam XPS boards, then apply primer composition and first layer of basecoat mortar. Press to insert the mesh into basecoat mortar without wrinkles or folds, with an overlap as designed. Finally apply the second layer of basecoat mortar to cover the mesh according to designed cover thickness.

EIFS specifications and technical requirements are different from one country to another. EIFS standard in Europe is put forward by European Organization for Technical Approvals (EOTA). This standard specifies all parts of EIFS and all technical performance requirements that the whole system should meet, including physical property, workability and on-site operation requirements, such as water absorption, vapor permeability, bonding strength, and anti-impact performance, etc.

In China, the Ministry of Construction issued the first EIFS industry standard, “External thermal insulation composite systems based on EPS” JG 149-2003 on Jul. 1, 2003. A more general standard, JGJ144-2004 “Technical specification for external thermal insulation on walls”, was issued in January in 2005. Which standard was led by the Center of Science & Technology of Construction in MOC, while CABR, China Institute of Building Standard Design & Research, participated in the editing work. JG 149-2003 was quite similar to EOTA ETAG 004 in Europe. It mainly introduced the external insulation system of the EPS board with thin rendering coat & finishing. JGJ144-2004 indicates the great attention and participation of EIFS technologies by a number of companies. This standard brings the system of JG149-2003 into its own, while it also makes a further expansion and specifies other three kinds of EPS-based technology (concrete wall cast-in-site with EPS board, concrete wall cast-in-site with metal network holding EPS board, EPS board with metal network fixed by mechanical fasteners). It is true that it has played the most important role in China EIFS market right now.

Relevant testing methods introduced here are mainly based on JG149-2003 and JGJ144-2004, and some contents in Shanghai local standard DB31/T366-2006 ‘Technical Requirements of Polymer Mortar for External Thermal Insulation’ are also be partially adopted.

JGJ144 Basecoat Mortar Bonding Strength (to XPS board)

The bonding strength to XPS test following JGJ144 is exemplified as follows:

1. The test dimension is 100 mm×100 mm, and the thickness of XPS board is 50 mm. The number of samples is 5.

2. Sample preparation method is described as follows: coat adhesive on one surface of XPS, with thickness (3±1) mm. After curing, coat appropriate adhesive (such as epoxy) on two sides to bind steel bottom board of dimension 100 mm×100 mm.

3. The test should be performed under the following states:
Under dry state after standard curing for 28 days, called dry bonding strength
Standard curing for 28 days, immersed in water for 48 h, 2 h after taking out, called wet bonding strength
After standard curing for 28 days, the following circulation (in dry box at 50±3° C. for 16 h, immersed in water at 23±3° C. for 8 h, with sample basecoat layer at lower part, water level at least 20 mmm higher than sample surface, then frozen at −20±3° C. for 24 h, called one circulation) performed for 10 cycles in 20 days. This strength is called freeze-thaw bonding strength

4. Install sample on tensile testing machine with tensile speed 5 mm/min, and pull the sample until breakage, then record the tensile force and breakage position when breakage occurs.

5. The testing result is represented by arithmetical mean of testing data for 5 samples.

JG149 Bonding Strength

The bonding strength test following JG149 is exemplified as follows:

1. The sample mainly consists of cement mortar bottom board (or XPS board) of 70 mm×70 mm and tensile steel clamp of 40 mm×40 mm.

2. The number of samples bonding with cement mortar (or XPS board) is 6, and the preparation method described as follows: prepare adhesive according to product instructions, and coat the adhesive on cement mortar bottom board (or XPS board), then bind steel clamp, with adhesive thickness 3 mm and area 40 mm×40 mm.

3. The test should be performed under the following states:
Under dry state after standard curing for 14 days (called dry boning strength)
Standard curing for 14 days, immersed in water at 23±3° C. for 7 days, 2-4 h after taking out (called wet bonding strength)
After standard curing for 14 days, the following circulation (in dry box at 50±3° C. for 16 h, immersed in water at 23±3° C. for 8 h, with sample basecoat layer at lower part, water level at least 20 mmm higher than sample surface, then frozen at −20±3° C. for 24 h, called one circulation) performed for 10 cycles in 20 days. This strength is called freeze-thaw bonding strength.

4. Install the sample on tensile testing machine and set the tensile speed at 5 mm/min, pull the sample until breakage, then record the tensile force and breakage position when breakage occurs.

5. The testing result is represented by arithmetical mean of 4 medium values.

The “open time” is measured as follows:

After preparation of polymer mortar, place the sample in testing environment according to operable time provided by system supplier and then perform test in accordance with the testing method used in dry bonding strength.

Bending Strength

For bending strength, refer to GB/T17671-1999 ‘Test method of cement mortar strength’. Standard testing conditions are: ambient temperature 23±2° C., relative humidity 50±5%, air speed in testing area less than 0.2 m/s. Age of polymer mortar is 28 days and the dimension is 40 mm×40 mm×160 mm. Prepare sample according to specification requirements.

Testing machine is made in the following way: clip the mortar bar of 40 mm thickness with three steel cylinder axles of 10 mm diameter; place 2 steel cylinders at one side with 100 mm distance between them and another steel cylinder in the middle of the other side; clamp down on mortar bar, see the diagram below.

Bending strength R_{f} is represented by MPa, and calculate according to the formula below:

$${R}_{f} = \frac{1.5 {F}_{f} L}{{b}^{3}}$$

Where

F_{f}: load applied on the middle part of sample at bending (N)

L: distance between support cylinders (mm)

b: side length of sample square section (mm)

Arithmetic mean of testing values for 3 testing pieces is taken as the testing result, to the accuracy of 0.01 MPa.

Compressive Strength

For compressive strength, also refer to GB/T17671-1999 ‘Test method of cement mortar strength’. Age of polymer mortar is 28 days and the dimension is 40 mm×40 mm×160 mm. Prepare sample according to specification requirements. However, this test is performed on the lateral face of bent sample (i.e. half prism) after bending test is completed. The difference between centers of this half prism and pressing machine pressboard is required to be within 0.5 mm.

During loading, apply load uniformly at the speed of 2400±200 N/s until breakage. Compressive strength Rc is represented by MPa, and is calculated according to the formula below:

$${R}_{c} = \frac{{F}_{c}}{A}$$

Where

F_{C}: Maximum load at breakage (N)

A: area of part in compression 40 mm×40 mm=1600 mm2

Arithmetic mean of measuring values for 6 testing pieces is taken as the testing result, to the accuracy of 0.01 MPa.

Water Absorption (Small-Scale System)

Water absorption measurement is exemplified as follows:

1. Sample size is 200 mm×200 mm, and the number of samples is 3.

2. Sample preparation: coat basecoat mortar on XPS board of 50 mm thickness according to the requirements of supplier, press and embed mesh with basecoat mortar, with total thickness 5 mm. After curing for 28 days in testing environment, cut the sample in accordance to size requirements of test.

3. Except for basecoat mortar surface for each sample, all the other 5 surfaces should be sealed with waterproof materials.

4. Test process: firstly, measure the mass of sample, then put the sample with basecoat mortar surface toward downside in the water at indoor temperature, with underwater penetration equivalent to basecoat mortar thickness. After the sample is immersed in water for 24 h, take it out and wipe out the water on the surface, weigh the mass of sample after water absorbing for 24 h.

5. The testing result is represented by arithmetic mean of 3 testing results, to the accuracy of 1 g/m².

Anti-Impact Performance (Small-Scale System)

Anti-impact test is exemplified as follows:

1. Testing apparatus: steel ruler, measurement range 0-1.02 m, division value 10 mm; steel balls with mass respectively 0.5 kg and 1.0 kg.

2. Sample size: 600 mm×1200 mm, number of samples: 2. Preparation method: coat basecoat mortar on XPS board of 50 mm thickness according to the requirements of supplier, press and embed mesh with basecoat mortar, with total thickness 5 mm. After curing for 28 days in testing environment, cut the sample in accordance to size requirements.

3. Test process: place the sample flatly on level ground with basecoat toward upside, and the sample should be tightly close to the ground; use 0.5 kg (1.0 kg) ball and loose it at the height of 0.61 m (1.02), let the ball fall freely and impact the sample surface. 10 points should be impacted for each level, and at least 100 mm should be left between points or point and edge.

4. Testing result: breaking of basecoat mortar surface is considered as breakage, if breakage occurs for less than 4 times of 10 times, anti-impact performance for this test is up to standard; if breakage occurs for 4 times or more in 10 times, anti-impact performance for this test is not up to standard.

Water Tightness (Small-Scale System)

Water tightness measurement is exemplified as follows:

1. Sample size and number of samples: size 65 mm×200 mm×200 mm, number of samples: 2.

2. Sample preparation: use XPS board of 60 mm thickness and prepare sample with the method used in system water absorption test, remove XPS board in the central part of sample and the dimension of removed part is 100 mm×100 mm, then mark the position (on lateral face of sample) 50 mm away from basecoat mortar surface.

3. Test process: place the sample in such a way that its basecoat mortar surface is toward downside, and its basecoat layer locates at 50 mm position under water surface, and put heavy objects on the sample to ensure that the sample is under water. Observe inner surface of the sample after it is kept under water for 2 h.

4. Testing result: if there is no water seepage for the part on the back of the sample with XPS board removed, it is up to standard.

JG149 Freeze-Thaw Resistance (Small-Scale System)

Freeze-thaw resistance test following JG149 is exemplified as follows:

1. Testing apparatus: freezing box: minimum temperature −30° C., control accuracy ±3° C.; drying box: control accuracy ±3° C.

2. Sample dimension 150 mm×150 mm, sample numbers: 3. Use XPS board of 50 mm thickness and prepare sample with the method used in system water absorption test, then coat finish layer (painting or ceramic tile) on basecoat mortar surface.

3. Test process: keep the sample in drying box at 50±3° C. for 16 h, then immerse it in water at 20±3° C. for 8 h, with sample basecoat toward downside and water level at least 20 mm higher than sample surface; keep it in freezing box at −20±3° C. for 24 h, and this is a circulation. Observe the sample one time for each circulation. The test is over after 10 cycles.

4. Testing result: after the test is over, observe that there is no blowing, spelling, blister or de-bonding with the surface, and also observe that there is no crack with the surface under a 5× magnifier.

JGJ144 Freeze-Thaw Resistance (Small-Scale System)

Freeze-thaw resistance test under JGJ144 is exemplified as follows:

1. Sample dimension 500 mm×500 mm; sample number 3. Use XPS board of 50 mm thickness and prepare sample with the method used in system water absorption test, then test the following 2 kinds of samples: with or without finish layer (painting or ceramic tile).

2. Test process: freeze-thaw circulation for 30 times, each time for 24 h. Immerse sample in water at 20±2° C. for 8 h, with sample basecoat toward downside and basecoat layer immersed in water; freeze it in freezing box at −20±2° C. for 16 h, and this is a circulation. Observe the sample one time for each 3 circulations. The test is over after 30 circulations of the sample.

3. Testing result: observe that there is no blowing, spalling, blister or de-bonding with the surface after each 3 circulations, and record this. After the test is over, curing the samples in lab conditions for 7 d, and test dry bonding strength according to the method described above.

Water Permeability (Small-Scale System)

Water Permeability Test is Exemplified as Follows:

Vapor permeability refers to vapor permeation flowing across unit area within unit time. Unit: g/(m2·h) or kg/(m2·s). Vapor permeability in JG149-2003 is measured in accordance to regulation of water method in GB/T17146-1997 ‘Test methods for water vapor transmission of building materials’. Seal EIFS sample (finish surface toward downside) on the test cup (with definite quantity of water in it), place the cup in the environment with constant temperature 23° C. and constant relative humidity 50% after weighing it. There is humidity difference between relative humidity 100% of water in the cup and relative humidity 50% of lab, so the vapor in the cup will diffuse to the lab. Weigh the weight of the test cup regularly, and vapor permeability of EIFS can be calculated.

Generally speaking, painting layer has great effect on this target. While in tile finish system, this target entirely depends on the width of tile gap and permeation of joint (grouting) materials.

Vapor permeability 0.85 g/m2 h specified in JG149-2003 amounts to medium level of permeation. As far as EIFS is concerned, permeation difference in different components of a wall may lead to wall dewing, and long term of this will cause wall mould and system damage. JG149 requires:
1. After preparing sample according to specified method, coat painting on basecoat layer and remove XPS board after drying. Sample thickness should be 4.0±1.0 mm with sample painting (or ceramic tile) surface toward the side of less humidity.
2. In addition, the system without finish layer (painting or ceramic tile) can also be tested.

Full-Scale System Weathering Test

Full-scale system weathering test is exemplified as follows:

1. Testing Apparatus and Equipments:
a) Weathering test box: temperature control range −25° C.-75° C., with the temperature regulation via warm air and automatic spray equipment is part of the box. Temperature control device locates at the position 0.1 m away from EIFS surface, and the number is not less than 4. Test box can automatically control and record EIFS surface temperature.

b) Test wall: concrete or masonry wall, test wall should be solid enough to be installed on weathering test box. Make an opening of 0.4 m wide and 0.6 m high at the position where the upper part of test wall is 0.4 m away from the edge, and window frame should be installed at the opening. Test wall size shall meet: area not less than 6.0 m²; width not less than 2.5 m; height not less than 2.0 m.

2. Sample Curing Condition:

In the room with ambient temperature (10-25)° C., relative humidity more than 50%.

3. Sample Molding and Curing:

a) Sample requirements: prepare EIFS sample on test wall according to EIFS structure and construction method specified by supplier. Sample area and size should be in accordance with regulations. EIFS should extend for the side surface of test wall opening, the thickness of insulation board should not be less than 50 m and the thickness of insulation board at the side surface of opening should not be less than 20 mm. Only one type of finish or at most four types of finish are used for sample and it is not taken as finish layer at 0.4 m height of wall bottom. When different kinds of finish coat are adopted, the length of finish should equal to that of test wall and uniformly distributed along the height direction.

b) Insulating material: use materials of the same quality to infill the joint of insulation board; check and record such installation details as description of materials, quantity, board joint position, and number and position of mechanical fixing, etc.

c) Basecoat layer: prepare basecoat mortar according to supplier specifications; check and record coat making details, such like description of materials, quantity, and mesh overlap position, etc.

d) Finish layer: basecoat layer at the joint of different kinds of finish coat is not allowed to be exposed.

e) Curing: sample should be cured for at least 28 days after the last basecoat mortar is completed.

4. Test Process

a) Heating/rain circulation for 80 times

Heating for 3 h: increase the surface temperature of sample to 70° C. within 1 h, and keep sample at constant temperature for 2 h under the condition of (70±5)° C. and (10-15) % RH;

Water spraying for 1 h: water temperature (15±5)° C., spraying volume (1.0-1.5) L/(m²·min);

Placing for 2 h;

Observe the surface after each 4 heating/rain circulations, check the blister, cracking or spalling of basecoat and finish layer, and record its size and position.

b) Freeze-thaw circulation for 5 times

Place sample for 48 h after heating/rain circulation is completed, and then perform freeze-thaw circulation;

Heating for 8 h: increase the surface temperature of sample to 50° C. within 1 h, and keep sample at constant temperature for 7 h under the condition of (50±5)° C. and (10-15) % RH;

Freezing for 16 h: reduce the surface temperature of sample to −20° C. within 2 h, and keep sample at constant temperature of (−20±5)° C. for 14 h;

Observe the surface after each freeze-thaw circulation, check the blister, cracking or spalling of basecoat and finish layer, and record its size and position.

5. Performance Testing

Place sample for 7 days after freeze-thaw circulation, and then perform bonding strength testing. For painting, stucco, tile finish, the basecoat mortar to insulation board bonding strength should be tested and cut the surface layer to insulation board surface. Both cutting line spacing and the distance away from finish coat edge should not be less than 100 mm. Take the average value for 3 samples in tensile bonding strength as the testing result, to the accuracy of 0.01 Mpa. If ceramic tile is taken as the finish, tensile bonding strength of tile to basecoat layer should also be tested, and cut the surface to basecoat mortar surface. Take the average value for 3 samples in tensile bonding strength as the testing result, to the accuracy of 0.01 Mpa.

The present invention is further demonstrated with the following non-limiting examples.

### EXAMPLES

1. Materials

STYROFOAM*: 50 mm thickness Wallmate EX board was selected for sole insulation materials for test, the specification listed in Table 1.

TABLE 1
Specification of STYROFOAM* Wallmate EX

| | | STYROFOAM* |
|---|---|---|
| PRPERTIES | Test Method | WALLMATE EX |
| Thermal resistance, 24° C., 180 | ASTM C518 | R5 at 25.4 mm |
| days | | (0.029 W/m · K) |
| Compressive strength | ASTM D1621 | 29 psi (200 kPa) |
| Flexural strength | ASTM C203 | 50 psi (345 kPa) |
| Water absorption | ASTM C272 | 0.1%-vol. |
| Water vapor permeance, 25 mm | ASTM E96 | 1 perm (58 ng/sPam²) |
| Dimensional stability | ASTM D2126 | 2% |
| Flame spread | ASTM E84 | 5 |
| Smoke development | ASTM E84 | 165 |
| Thickness | N.A. | 50 mm |
| Length | N.A. | 1,250 mm |
| Width | N.A. | 600 mm |
| Edge Profile | N.A. | butt edge |
| Surface | N.A. | planed |

Primer Composition: Four types of emulsion latexes that listed in Table 2 were evaluated in this study for treating the STYROFOAM* board surface. The effectiveness of improving bonding strength between mortar layer and STYROFOAM* was evaluated. Three UCAR latexes are produced by Dow. POLLYED 6400 produced by Shanghai Transea Chemicals Co., Ltd, has been widely used as XPS primer composition in the market serve as comparative sample.

TABLE 2
Characteristics of emulsion latexes used as primer compositions to treat
STYROFOAM* board surface

| | Primer Name | | | |
|---|---|---|---|---|
| | UCAR* | UCAR* | UCAR* | |
| | Latex | Latex | Latex | POLLYED |
| | R161N | U413B | S53 | 6400 |
| Polymer | Styrene-acrylic | Acrylic | Styrene- | Styrene- |
| Type | | | acrylic | acrylic |
| Weight | 55~57 | 46~48 | 49~51 | 55~57 |
| solid, % | | | | |
| Viscosity, | 400~1500 | 80 max. | 2500~8000 | 1000~6000 |
| cps | (Brookfield | (Brookfield | (Brookfield | (Brookfield |
| | LVT, | LVT, | LVT, | RVT |
| | #3/60 rpm | #1/60 rpm | #4/60 rpm | #4/60 rpm |
| | @25° C.) | @25° C.) | @25° C.) | @25° C.) |
| pH Value | 6~8 | 9~10 | 8~9 | 7~9 |
| Particle | 0.35 | 0.2~0.4 | 0.07~0.13 | 0.2~0.4 |
| Size, | | | | |
| micron | | | | |
| MFFT, ° C. | <0 | 11 | 16 | 0 |
| Tg, ° C. | −11 | 13 | 17 | −6 |

RDP: three types of RDP listed in Table 3 were compared. DLP 2140 is Dow's grade that designed for EIFS. The improvement to adhesion property from DLP 2140 is compared with the other two RDP that produced by WACKER and National Starch respectively. RE5044N produced by WACKER and FX 2350 from National Starch.

TABLE 3
Characteristics of RDP

| | Grade Name | | |
|---|---|---|---|
| | | VINNAPAS | ELOTEX |
| | DLP 2140 | RE5044N | FX2350 |
| Provider | Dow | WACKER | National Starch |
| Polymer Type | Vinylacetate/ | Vinylacetate/ | Vinylacetate/ |
| | Ethylene | Ethylene | Ethylene |
| Tg, ° C. | 6 | −7 | −8 |
| MFFT, ° C. | 0 | 0 | 0 |
| Ash Content, % | 10~14 | 8~12 | 8~12 |

CE: Three types of CE listed in Table 4 were compared. Two of which were Dow METHOCEL*. METHOCEL* CP 1425, previously named METHOCEL* XCS 41425, is a grade designed for thermal insulation systems which imparts outstanding workability. METHOCEL* 306 is a universal grade for cement-based applications with balanced properties. Culminal C8681 is a methylcellulose provided by Hercules primarily designed for cement mortar system.

TABLE 4
Characteristics of cellulose ethers

| | | | Hercules |
|---|---|---|---|
| | METHOCEL* | METHOCEL* | Culminal |
| Typical Property | 306 | CP 1425 | C8681 |
| Viscosity Brookfield | 5300 | 2500 | |
| RV (mPa · s) | | | |
| 1% in water @ | | | |
| 20° C. and 20 rpm | | | |
| Viscosity Brookfield | 41000 | 22000 | 55000~70000 |
| RV (mPa · s) | | | |
| 2% in water @ | | | |
| 20° C. and 20 rpm | | | |
| Moisture Content (%) | <6.0 | <7.0 | |
| Sodium Chloride (%) | <2.0 | <2.0 | |
| Particle Size (%) | >98 | >95 | |
| <70 U.S. Standard | | | |
| Sieve, 212 μm | | | |

Cement: Two types of cements purchased from local market are listed in Table 5. P•II indicates Portland cement with inert filler less than 5% while P•O indicates ordinary cement with unknown active filler in the range of 6˜15%. “52.5” and “42.5” are corresponding strength level for each cement grade.

TABLE 5
Characteristics of cements

| | Xiaoyetian P.II 52.5 | Lianhe P.O 42.5 |
|---|---|---|
| Provider | Shanghai Sanhang | Shanghai Lianhe |
| | Xiaoyetian Cement | Cement Co., Ltd. |
| | Co., Ltd. | |
| Composition | Pure silicate with | Silicate with |
| | inert filler less | active filler in the |
| | than 5% | range of 6~15% |
| Compressive | 23.0 | 16.0 |
| Strength, | | |
| 3 days, MPa | | |
| Compressive | 52.5 | 42.5 |
| Strength, | | |
| 28 days, MPa | | |
| Bending Strength, | 4.0 | 3.5 |
| 3 days, MPa | | |
| Bending Strength, | 7.0 | 6.5 |
| 28 days, MPa | | |

2. Methods

2.1 Sample Preparation Methods

The mortar composition normally is adjusted in according to the level from different components. A general formulation example is listed in Table 6.

TABLE 6
Typical adhesive mortar composition for EIFS application

| Ingredient | Parts in weight |
|---|---|
| Portland cement | 250~350 |
| Quartz sand (0.1~0.3 mm) | 550~650 |
| Calcium Carbonate (0.08 mm) | 80 |
| Re-dispersible Polymer Powder | 25~30 |
| Cellulose Ether | 1~3 |
| Other Additives | 1~2 |
| Water | 220~270 |

Procedure to prepare mortar layer samples for the bonding strength tests: all components were mixed by using the mixer specified in China code JC/T 681 to produce the adhesive mortar. The water was first put into the mixing bowel, followed by adding the dry components. The mixing action takes about 60 seconds at low velocity and stopped, the mixing blades then were cleaned and the mixing bowel was scraped to incorporate unmixed dry components. After 10-15 minutes, another mixing action would be conducted again by following the same procedure.

When primer composition treatment was needed, the primer composition was first diluted by water in accordance with the prescribed ratios and applied on STYROFOAM* surface once or twice within time period that long enough for water to be full evaporated and the film became transparent.

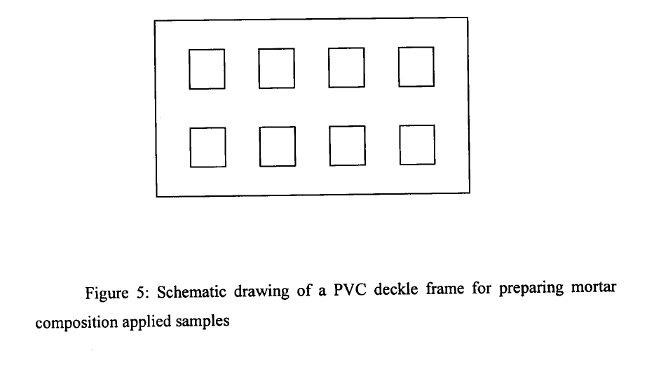

For mortar layer sample preparation, the PVC deckle frame (shown as FIG. 5) was placed on a substrate (concrete or STYROFOAM* board). It had 8 evenly spaced 50 mm×50 mm cavities and was 3 mm thick. The well-mixed mortar composition was cast on the deckle frame and filled in all cavities. The mortar layer was smoothed with a trowel and the deckle frame was then removed carefully. The samples were then cured for 7 days in a constant temperature and humidity room (23° C. and 50% humidity).

2.2 Bonding Strength Types in the Evaluation

According to Chinese codes, there are numbers of test methods for bonding strength, such as Dry Strength, Wet Strength, High Temperature Strength, and Freeze-thaw Strength, to accelerate this evaluation and based on lab experience, three type of strength were chosen for this evaluation work.

Dry Bonding Strength

After curing the mortar layer samples for 6 days (or 13 days when required), a 50 mm×50 mm×10 mm metal piece with a threaded hole at the back was glued to the surface of the mortar layer with an epoxy glue. After curing the epoxy, say 24 hours late, the metal piece was jointed with a tensile tester and pulled perpendicularly to the substrate at a velocity of 5 mm/min, the pull-off force was recorded.

Wet Bonding Strength

The 7-day (or 14-day) cured metal glued samples were immersed in water at 20° C. for additional 2 days (or 7 days), and then dried for 4 hours prior to the tensile test.

High Temperature Bonding Strength

The 7-day cured metal glued samples were further cured in 50° C. environment for additional 7 days prior to the tensile test.

3. Testing Results and Discussion

3.1 STYROFOAM* Board

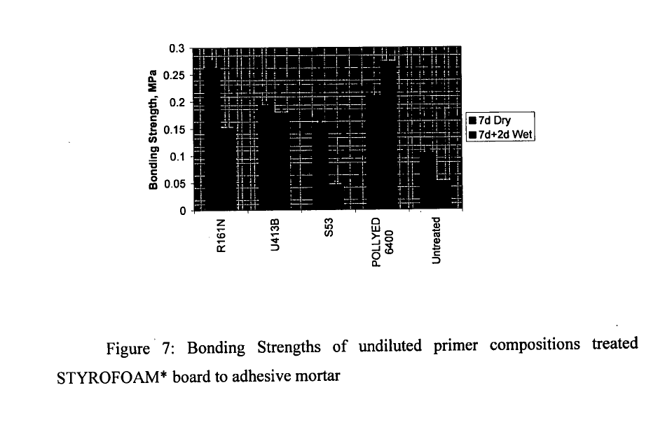

The inherent tensile strength of STYROFOAM* board is believed to have relationship with its thickness. The test was conducted according China national EPS EIFS standard JG 149-2003, the STYROFOAM* board was cut into small piece of 70 mm×70 mm with different thicknesses, 20 mm, 25 mm and 40 mm. A 40 mm×40 mm metal piece was directly glued to STYROFOAM* with an epoxy. After the epoxy was cured, the tensile force was measured and results are shown in FIG. 7.

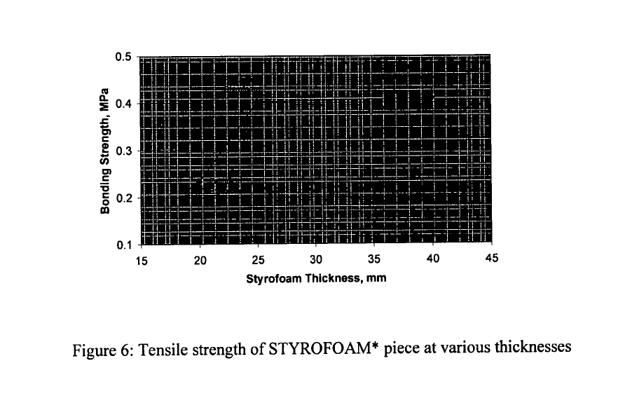

It can be seen from FIG. 6 that the thicker the STYROFOAM* piece, the bigger the tensile strength. This is due to the different shear stress distributions in STYROFOAM* board of different thicknesses during the tensile test. Failure model observed showed that the thin piece was easy to pull off inside STYROFOAM* while the thick one failed at the STYROFOAM* skin or interface with mortar layer. As 50 mm thickness STYROFOAM* board was used in this study, it's difficult to observe STYROFOAM* failure unless the bonding strength imparted by the layer of the cement mortar exceeds 0.4 MPa. With a smaller de-bonding strength, the failure only occurs at the interface.

3.2 Primer Composition

Four types of emulsions are evaluated in this study. Since the primer compositions were usually diluted by water during on site application, a standard formulation (shown in Table 7) then was designed to test the primer composition performance.

TABLE 7
Formulation used to evaluate primer compositions

| Ingredient | Parts in weight |
|---|---|
| Portland cement (Xiaoyetian cement P-II 52.5) | 320 |
| Quartz sand (0.16~0.3 mm) | 220 |
| Quartz sand (0.125~0.25 mm) | 352 |
| CaCO3 (0.08 mm) | 80 |
| DLP 2140 | 25 |
| METHOCEL* CP 1425 | 1.5 |
| Wood fiber: Technocel (National Starch) | 1.5 |
| Water | 220 |
| XPS board | STYROFOAM* 50 mm |

Both dry and wet bonding strength were measured and compared. FIG. 7 indicates the bonding strength of the samples treated by the undiluted primer compositions. It's obvious that the bonding strengths with STYROFOAM* board were largely improved after treating, no matter treated by which primer composition. R161N showed largest improvement in terms of dry adhesion strength among the four primer compositions, which was 2.5 times larger than the untreated one 0.1 MPa. POLLYED 6400 behaved best wet adhesion, resulting 5 times larger than the untreated one, while R161N also had 3 times improvement in wet adhesion. The samples treated by undiluted S53 showed similar bonding strength with the untreated, indicating mild improvement in wet adhesion.

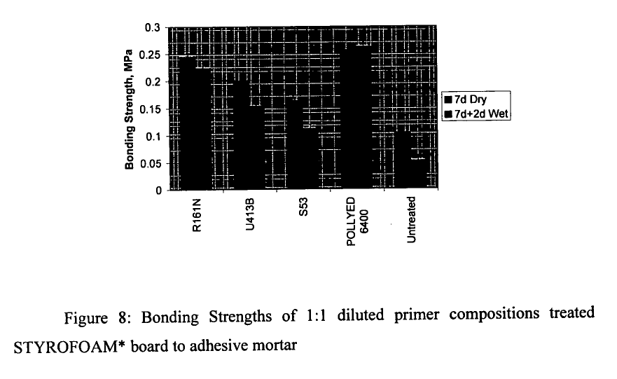

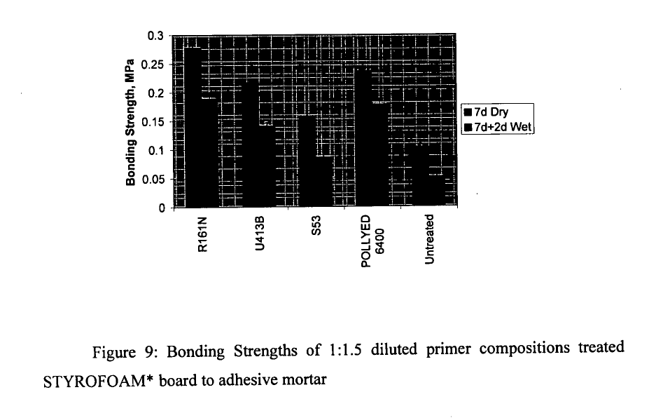

The bonding strength at different dilution ratios at 1:1 and 1:1.5 were also tested and the results were shown in FIG. 8 and FIG. 9 respectively. Even under different dilution ratios, four primer compositions constantly provided large improvement to the bonding strengths. It's found that R161N and POLLYED 6400 were the best two candidates in the whole range from no dilution to 1:1.5 dilution. While the improvement from S53 was the least in according to the data collected from this study. This is probably because R161N is designed to provide more flexibility with its lower Tg, −11° C. The films formed by U413B and S53 somehow are more rigid under certain temperature range due to the higher Tg, 13° C. and 17° C. respectively. From the wet adhesion strength aspect, diluted S53 performed better than that of undiluted one but the mechanism was not clear and need further investigation. Overall speaking, R161N out-performed than the requirements and was selected as the primer composition to STYROFOAM* board in the EIFS.

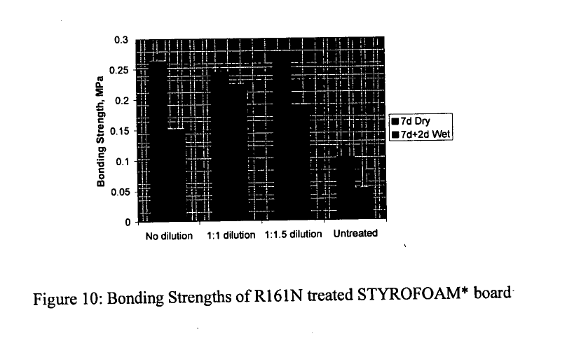

The R161N performance at different dilution ratios were shown in FIG. 10. Various dilution ratios seems do not bring any difference to the dry adhesion where the bonding strengths were kept at 0.25˜0.3 MPa consistently. Wet adhesion was stronger under larger dilution ratios. When using diluted primer composition, cost and workability are two key factors that shall be put into consideration. High dilution ratio reduces cost of primer composition, but the over-dilution primer composition showed inverse impact on the workability from the lab experiments. Our observation is the water beads appeared and remained on the STYROFOAM* board and the primer composition could not be spread evenly. In conclusion, the dilution ratios 1:1.5˜1:2 were recommended with a balance of good workability and low cost. In order to lower labor cost, the applying cycles of primer composition may be reduced to one, but a second round applying is needed if the previous treatment can not provide enough surface covering.

3.3 Re-Dispersible Polymer Powder

The standard formulation designed for the RDP comparison was listed in Table 8. DLP 2140 was compared with other two RDP from WACKER and National Starch. The specifications are shown in Table 3. It is noted that the ordinary cement and the un-treated STYROFOAM* board were used in this test, because the purpose of this test is to quick judge raw materials performance at early stage, whether DLP 2140 was comparable with competitors' RDP in terms of the adhesion behavior at various conditions, rather than providing an optimal formulation for the whole EIFS system. Walocel MKX 45000 is a methyl hydroxyethyl cellulose from Bayer with a viscosity range of 40000˜50000 mPa·s (ROTOVISKO, 2% solution, 20° C.).

TABLE 8
Formulation used for RDP comparison

| Ingredient | Parts in weight |
|---|---|
| Ordinary cement (Lianhe P.O 42.5) | 350 |
| Quartz sand (0.16~0.3 mm) | 617 |
| RDP | 30 |
| Walocel MKX 45000 | 3 |
| Water | 230 |
| XPS board | STYROFOAM* 50 mm |
| | without primer |

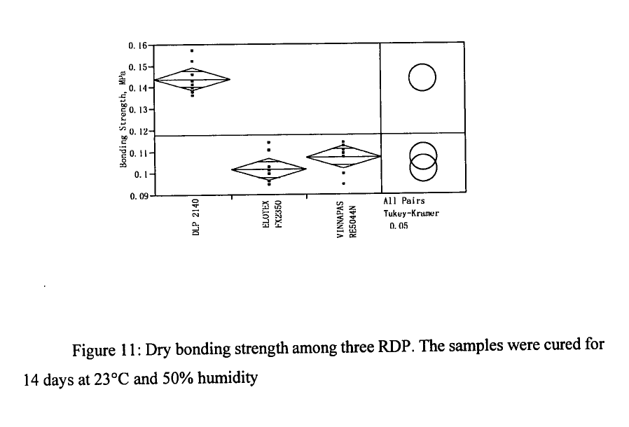

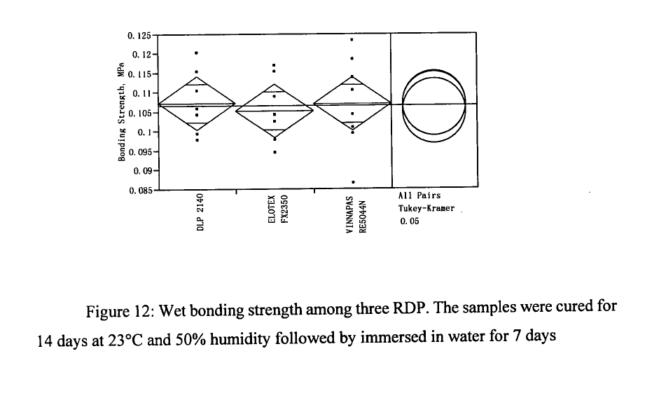

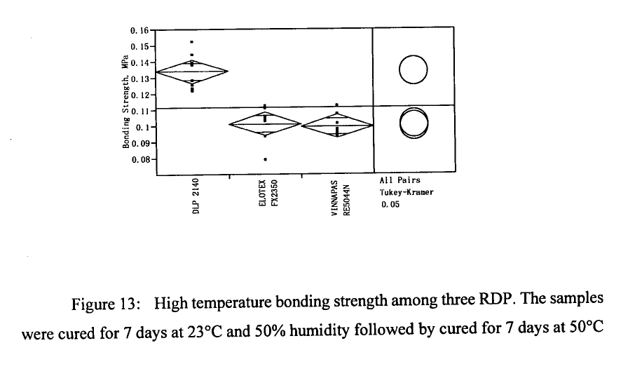

We added 30 parts of every RDP into the formulation and measured the dry, wet and high-temperature bonding strengths to STYROFOAM* board. The results are shown in FIG. 11, FIG. 12 and FIG. 13 respectively. Due to the absence of primer composition, the bonding strengths at all conditions were relatively low, in the average of 0.1˜0.15 MPa. It was observed during the testing that all failures occurred in the STYROFOAM*-mortar layer interface which means the bonding strengths were not large enough to break the STYROFOAM* board. DLP 2140 provided slightly larger dry and high temperature adhesion than ELOTEX FX2350 and VINNAPAS RE5044N. However, three RDP imparted comparable wet adhesion strengths to STYROFOAM* as found in FIG. 12.

Two conclusions can be made based on these data,
I. At 30 parts level, DLP 2140 is comparable to competitors' RDP on the effect of improving adhesion to STYROFOAM*, even slightly better at dry and high temperature conditions.
II. On the other hand, the poor adhesion to STYROFOAM* without primer composition have been observed, which indicated the importance of primer composition.

3.4 Cellulose Ether

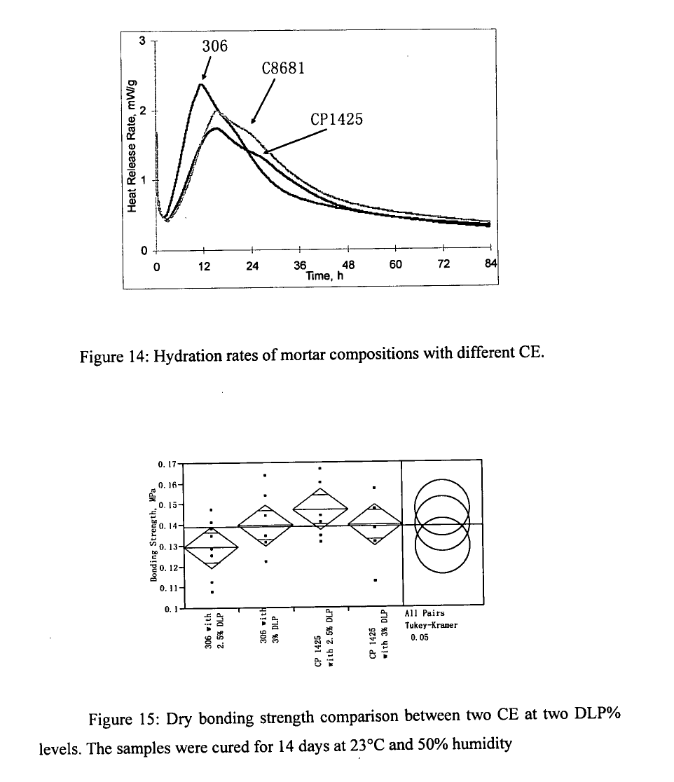

During summer time, cement mortar sets much quicker due to high ambient temperature. The newly produced wet mortar layer is easy to lose its workability unless the formulation is well designed. One important function that CE imparts into cement mortar is to slow down the hydration of cement and consequent increase the open time. Heat release rate of mortar lays in the hydration process is an important index to determine this function. In this test, we measure the heat released from the hydration process of CE modified mortar compositions by calorimeter device, TAM Air C08. The range of heat measurement is 0˜600 mW and temperature measurement is 15˜60° C. The samples were maintained in an environment at 20° C. and 60% humility. Results are shown in FIG. 14.

It shows that the mortar composition modified by METHOCEL* CP 1425 had slowest heat release rate in initial 24 hours, which indicates a good delay effect to the cement hydration process. The mortar composition modified by CP 1425 can have longer open time and high moisture retention than 306 and C8681, which is a key to the formulation designed for the summer climate.

Pull-off test on two Dow METHOCEL*s (listed in Table 4) was conducted by following the standard formulation shown in Table 9. Two dosage levels of DLP were tested, 2.5% and 3%, with 0.2% (by weight) of METHOCEL*s. The objective is to define whether METHOCEL*s have any negative impact on the bonding strength to XPS board and to compare the performance between 306 and CP 1425. Note that no primer composition was applied in this test.

TABLE 9
Formulation design for CE comparison test

| Ingredient | Part in weight | | | |
|---|---|---|---|---|
| Ordinary cement (Lianhe P.O 42.5) | 330 | 330 | 330 | 330 |
| Quartz sand (0.16~0.3 mm) | 573 | 573 | 568 | 568 |
| CaCO₃ | 70 | 70 | 70 | 70 |
| DLP 2140 | 25 | 25 | 30 | 30 |
| METHOCEL* 306 | 2 | | 2 | |
| METHOCEL* CP 1425 | | 2 | | 2 |
| Water | 210 | 210 | 225 | 220 |

| | |
|---|---|
| XPS board | STYROFOAM* 50 mm |
| | without primer |

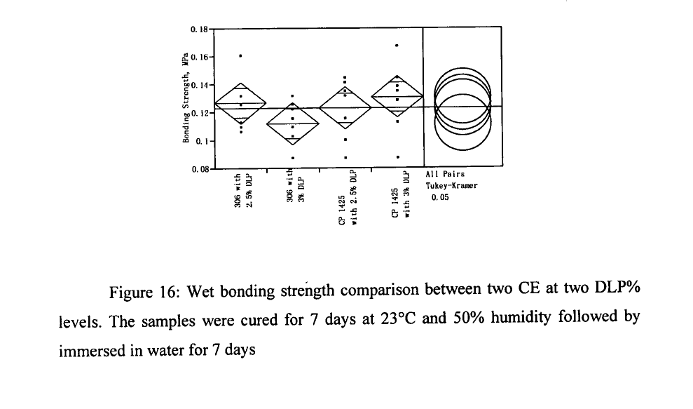

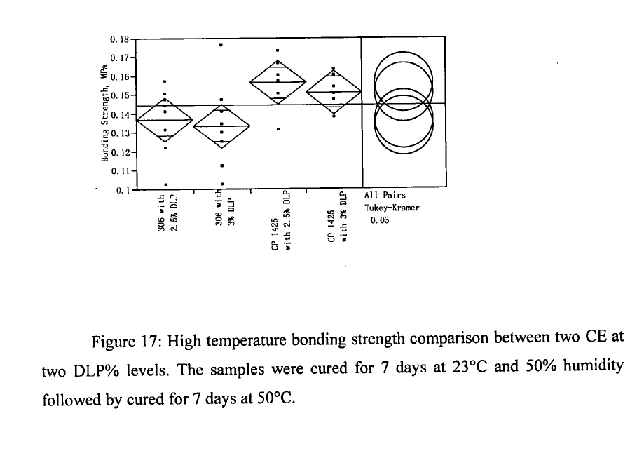

The mortar composition prepared from the formulations above all had good workability. Results from dry, wet and high temperature pull-off test are shown in FIG. 15, FIG. 16, and FIG. 17 respectively. It is obvious that most bonding strengths are in the range of 0.1˜0.15 MPa under all testing conditions, which indicates that both METHOCEL* 306 and CP 1425 have no negative impact on the adhesion property of the EIFS mortar composition. It is also confirmed both METHOCEL* 306 and CP 1425 at different DLP dosage levels had no difference statistically on the adhesion strength to STYROFOAM* under dry, wet and high temperature conditions.

It can be concluded that METHOCEL* CP 1425 has best delay effect to the cement hydration process so as to increase the open time. Both Dow METHOCEL* cellulose ether products did not affect the bonding strength of the system, but CP 1425 is more suitable for the EIFS formulation development.

3.5 Cement

The impact from cement type and cement purity on the adhesion property to STYROFOAM* has been tested. It's suggested to use pure Portland cement in EIFS so that Xiaoyetian P•II 52.5 Portland cement was extensively tested in this study. The standard testing formulation can be found in Table 10. Xiaoyetian cement ratio in the range from 25% to 37.5% was measured and two typical cement ratios 27.5% and 32.5% were compared between Xiaoyetian Portland cement and Lianhe ordinary cement. The adhesions to concrete and STYROFOAM* board (treated by R161N primer composition at dilution ratio of 1:2) were examined. The water ratio was adjusted to provide best workability.

TABLE 10
Formulation designed for cement evaluation test

| Ingredient | Parts in weight | | | | | | | |
|---|---|---|---|---|---|---|---|---|
| Xiaoyetian | 250 | 275 | 300 | 325 | 350 | 375 | | |
| P.II 52.5 | | | | | | | | |
| Portland | | | | | | | | |
| cement | | | | | | | | |
| Lianhe P.O | | | | | | | 275 | 325 |
| 42.5 ordinary | | | | | | | | |
| cement | | | | | | | | |
| Quartz sand | 722 | 697 | 672 | 647 | 622 | 597 | 697 | 647 |
| (0.125~0.25 | | | | | | | | |
| mm) | | | | | | | | |
| DLP 2140 | 25 | 25 | 25 | 25 | 25 | 25 | 25 | 25 |
| METHOCEL* | 3 | 3 | 3 | 3 | 3 | 3 | 3 | 3 |
| CP 1425 | | | | | | | | |
| Water | 250 | 260 | 270 | 270 | 270 | 270 | 260 | 270 |

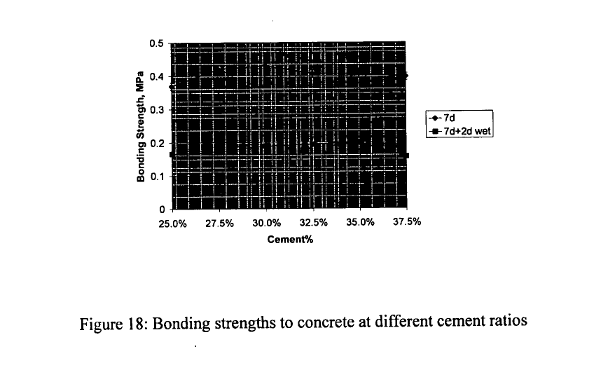

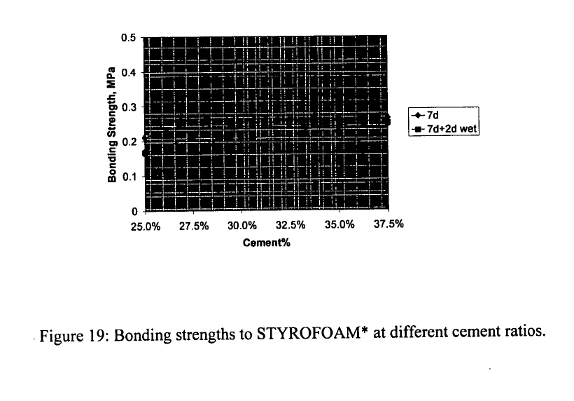

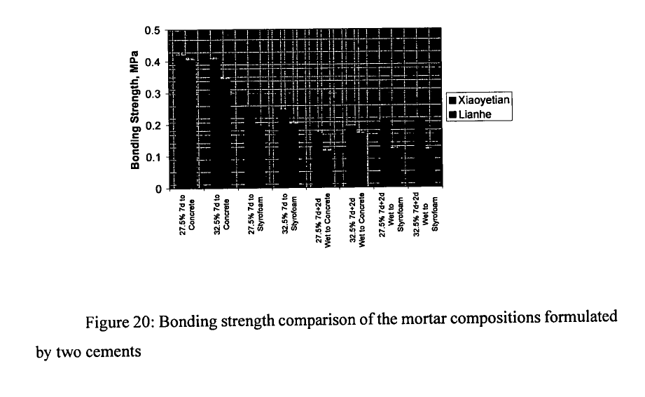

Results of dry and wet adhesion to concrete and STYROFOAM* are shown in FIG. 18, and FIG. 19. For both adhesions to concrete and STYROFOAM* board, it's hard to say the Xiaoyetian cement ratios at this range had impact on the bonding strength. The bonding strengths remained relatively constant to the increase of cement in the formulations. FIG. 18 shows much weaker wet adhesion to concrete than that in dry at all cement ratios, where the dry and the wet bonding strengths were stable at about 0.4 MPa and 0.2 MPa respectively. The adhesions to STYROFOAM* were quite similar at the dry and the wet testing conditions, as shown in FIG. 19. Both the bonding strengths were averagely 0.22 MPa, though the wet adhesion seemed to have higher values at increased cement ratios. It's obvious in FIG. 20 that no matter which cement ratios, substrates and/or adhesion conditions were employed; Xiaoyetian Portland cement had a better performance in terms of higher bonding strengths than Lianhe ordinary cement, which indicates inherent correlation between the bonding strength and cement types. Although both cements are quite dominant in local market, Xiaoyetian is more suitable for the EIFS application.

It's concluded that
1) The bonding strengths to two substrates, concrete and STYROFOAM*, and at two testing conditions, dry and wet, were independent to the cement ratio in the range from 25% to 40%.
2) Xiaoyetian P•II 52.5 Portland cement imparted higher bonding strengths at both 27.5% and 32.5% ratios, and to both concrete and STYROFOAM* substrates, and at both dry and wet conditions than Lianhe P•O 42.5 ordinary cement.

3.6 Water

Typically, water proportion for the polymer mortar is less than 30%. Outside of this range, the viscosity will be lower, and difficult to trowel to the wall substrate. On the other hand, it is expected that site workers will not measure water in a very accurate way, which means water ratio will vary by a certain degree in real practice. In the present invention, two water ratios, 22% and 25%, were tested. The formulations used are listed in Table 11. Two RDP % levels, 2.5% and 3%, were compared.

Workability means viscosity, ability of water retention or long open time, flow-ability. It's found that the workability of the mortar compositions formulated by 22% water was good while that by 25% water was a little bit thin, as shown in Table 11. The mortar composition adhesion was tested on two substrates, concrete and STYROFOAM* board (1:2 diluted R161N treated twice) and the dry and the wet adhesions were compared.

TABLE 11
Formulation design for water ratio evaluation test

| | |
|---|---|
| Ingredient | Parts in Weight |

| | | | | |
|---|---|---|---|---|
| Xiaoyetian P.II 52.5 Portland | 275 | 275 | 275 | 275 |
| cement | | | | |
| Quartz sand (0.16~0.3 mm) | 695 | 695 | 690 | 690 |
| DLP 2140 | 25 | 25 | 30 | 30 |
| METHOCEL* CP 1425 | 3 | 3 | 3 | 3 |
| Water | 220 | 250 | 220 | 250 |
| Workability | Good | Thin | Good | Thin |

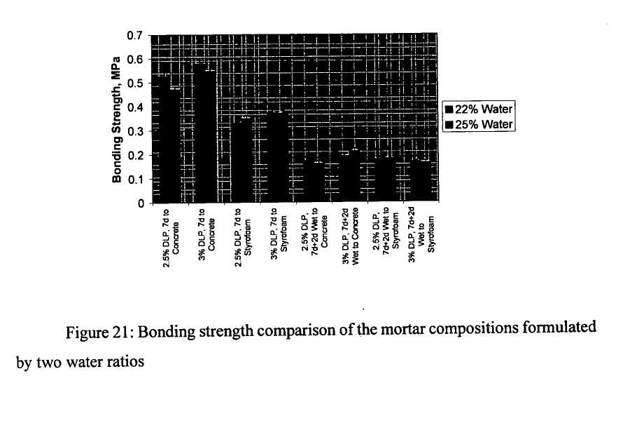

As shown in FIG. 21, the mortar compositions formulated by 22% and 25% water had similar bonding strengths at varied RDP % levels (2.5% and 3%), varied substrates (concrete and STYROFOAM*) and varied testing conditions (dry and wet). According to the results, it's believed that these series of formulations are workable for water ratios in the range from 22% to 25%, although the workability at 25% was found a little bit thin. With a 3% interval (even larger) of water ratios, the on site workers have more flexibility to add water while maintaining the consistent quality.

4. Selection of Various Components

In order to facilitate future EIFS system development, a raw materials evaluation study was conducted. Various components of EIFS mortar composition were evaluated in this study as well as STYROFOAM* board and primer compositions used to treat the STYROFOAM* board surface. Dry-mixing mortar composition or one component polymer mortar was focused, which was mainly composed of RDP, CE, cement, sand and water. The adhesion property of mortar composition formulated by those components and their individual influence to overall adhesion performance were examined. Based on the study, several conclusions can be drawn:
The inherent tensile strength of STYROFOAM* board increased with thickness. 50 mm thick STYROFOAM* board was so strong (>0.4 MPa) that the bonding strength imparted by the cement mortar could not break the board and created in-STYROFOAM* failure during tensile test.
As a primer composition, UCAR R161N emulsion latex showed the best performance. It improved both dry and wet adhesion on the STYROFOAM* board by over 3 times than the untreated. The dilution ratios in the range of 1:1.5˜1:2 were recommended with a balance of good workability and low cost.
DLP 2140 is equivalent to competitors' RDPs on the effect of improving adhesion to STYROFOAM*, even slightly better at dry and high temperature conditions. However, the fact of poor adhesion to w/o primer composition treated STYROFOAM* was observed.
METHOCEL* CP 1425 has best delay effect to the cement hydration process so as to increase the open time. Both two Dow METHOCEL* cellulose ethers tested in this study did not affect the bonding strength of the system.
The adhesion strength was independent to the cement ratio in the range from 25% to 40%. Xiaoyetian P•II 52.5 Portland cement imparted higher bonding strengths than Lianhe P•O 42.5 ordinary cement so that the P II 52.5 is suitable for EIFS development.
A 3% interval of water ratios from 22% to 25% was observed to have no influence to the overall adhesion strength. The series of formulations tested in this study were regarded to have good quality stability with large flexibility of water ratios.

5. Examples of Formulations

Example formulations (basecoat mortar) were made as follows:

TABLE 12
Example formulations (basecoat mortar).

| | Inventive | Inventive | Inventive |
|---|---|---|---|
| Components | example 1 | example 2 | example 3 |
| Cement | 280 | | |
| CaCO₃ | 80 | | |
| (0.075 mm) | | | |
| Quartz sand | 300 | | |
| (0.16-0.30 mm) | | | |
| Quartz sand | 308 | 306 | 304 |
| (0.12 mm-0.25 mm) | | | |
| Re-dispersible | 28 | 30 | 32 |
| powder | | | |

| | |
|---|---|
| Cellulose ether | 2 |
| Hectorite clay | 2 |
| Total weight of | 1000 |
| solids above | |
| Water | 22% |

Note:
total weight of solid components is 1000 by weight; water percentage (22%) is by weight as well.

Re-Dispersible Powder (Acetic Acid Ethenyl Ester, Polymer with Ethane)

These formulations are based on our experience and some results of raw materials evaluation mentioned before and in consideration of special requirements of basecoat mortar, such as our target bonding strength to XPS board, pot-life time, flexibility, water absorption, water tightness and anti-impact performance. Please note all the testing method is the same in JG 149-2003, details can be found in the report below attached.

Procedure to prepare mortar composition samples for tests: all components were mixed by using the mixer specified in China code JC/T 681 to produce the adhesive mortar. The water was first put into the mixing bowel, followed by adding the dry components. The mixing action takes about 60 seconds at low velocity and stopped, the mixing blades then were cleaned and the mixing bowel was scraped to incorporate unmixed dry components. After 10-15 minutes, another mixing action would be conducted again by following the same procedure.

The properties of the mortar compositions are shown below:

TABLE 13
The properties of the mortar compositions.

| | | | | Typical code |
|---|---|---|---|---|
| | | | | requirements |
| | | | | for EIFS |
| | Inventive | Inventive | Inventive | based on |
| Formulation No. | example 1 | example 2 | example 3 | EPS |
| Dry bonding strength | 0.36 | 0.38 | 0.43 | 0.1 |
| to Styrofoam, MPa | | | | |
| Wet bonding strength | 0.33 | 0.34 | 0.34 | 0.1 |
| to Styrofoam, MPa | | | | |
| Freeze-thaw bonding | 0.35 | 0.35 | 0.36 | 0.1 |
| strength to Styrofoam, | | | | |
| MPa | | | | |
| 2 h open time Dry | 0.37 | 0.39 | 0.45 | 0.1 |
| bonding strength, MPa | | | | |
| 24 hr Water | 384 | 352 | 328 | 500 |
| absorption, g/m² | | | | |

The test results show that high bonding strengths, long port-life time and better water absorption are achieved with the dry mortar composition of the invention. The typical code requirements for EIFS based on EPS, in contrast, exhibits a marked lower values in mechanical strength and a marked higher value in water absorption (please note: for this value, the lower the better).

While the present invention may be susceptible to various modifications and alternative forms, the exemplary embodiments discussed above have been shown by way of example. However, it should again be understood that the invention is not intended to be limited to the particular embodiments disclosed herein. Indeed, the present techniques of the invention are to cover all modifications, equivalents, and alternatives falling within the spirit and scope of the invention as defined by the following appended claims.

What is claimed is:

1. A composite structure comprising an extruded polystyrene layer, a mortar layer and a layer of a primer composition, wherein
at least one surface of the extruded polystyrene layer is planed, and
the mortar layer is made from a mortar composition comprising:
re-dispersible powder,
cellulose ether,
one or more viscosity modification agents,
one or more hydraulic binders, and
one or more aggregates.

2.-3. (canceled)

4. The composite structure according to claim 1, wherein the primer composition is applied to the planed surface of the extruded polystyrene layer and the layer of the primer composition is present between the extruded polystyrene layer and the mortar layer.

5.-8. (canceled)

9. The composite structure according to claim 1, wherein the re-dispersible powder comprises vinyl ester-ethylene copolymer or vinyl acetate-ethylene copolymer.

10.-13. (canceled)

14. The composite structure according to claim 1, wherein the mortar composition comprises about 2 wt. % to about 5 wt. % of the re-dispersible powder.

15. The composite structure according to claim 1, wherein the cellulose ether comprises hydroxypropyl methyl cellulose ether.

16. (canceled)

17. The composite structure according to claim 1, wherein the mortar composition comprises about 0.1 wt. % to about 10 wt. % of the cellulose ether.

18. The composite structure according to claim 1, wherein the viscosity modification agent comprises a member of smectitie group of minerals.

19. (canceled)

20. The composite structure according to claim 1, wherein the viscosity modification agent comprises unmodified hectorite clay.

21. The composite structure according to claim 1, wherein the mortar composition comprises about 0.01 wt. % to about 1 wt. % of the viscosity modification agent.

22. (canceled)

23. The composite structure according to claim 1, wherein the mortar composition comprises about 0.1 wt % to about 0.3 wt. % of the viscosity modification agent.

24.-26. (canceled)

27. The composite structure according to claim 1, wherein the mortar composition comprises about 25 wt. % to about 35 wt. % the hydraulic binder.

28.-29. (canceled)

30. The composite structure according to claim 1, wherein the mortar composition comprises about 30 wt. % to about 70 wt. % of the aggregate.

31.-32. (canceled)

33. The composite structure according to claim 1, wherein the primer composition comprises emulsion polymer.

34. The composite structure according to claim 1, wherein the primer comprises polyacrylic emulsion.

35. The composite structure according to claim 4, wherein the primer composition is applied in an amount of about 2.5 g/m² to about 150 g/m² with each surface of the extruded polystyrene layer.

36. The composite structure according to claim 4, wherein the primer composition is applied in an amount of about 5 g/m² to about 50 g/m² with each surface of the extruded polystyrene layer.

37. The composite structure according to claim 4 wherein the primer composition is applied in an amount of about 20 g/m² to about 35 g/m² with each surface of the extruded polystyrene layer.

38.-41. (canceled)

42. A composite structure comprising an extruded polystyrene layer, a mortar layer and a polyacrylic emulsion layer, wherein
both surfaces of the extruded polystyrene layer are planed, upon which the polyacrylic emulsion layers are applied,
the mortar layer is further applied on the polyacrylic emulsion layers; and
the mortar layer is made from a mortar composition comprising:
about 2 wt % to about 5 wt % of vinyl ester-ethylene copolymer powder,
about 0.1 wt % to about 1 wt % of hydroxypropyl methyl cellulose ether,
about 0.1 wt. % to about 0.3 wt. % of unmodified hectorite clay,
about 25 wt % to about 35 wt % of cement, and
about 50 wt % to about 65 wt % of quartz sand.

43.-44. (canceled)

45. An exterior thermal insulation system for attachment to wall substrate comprising:
leveling screed;
stucco finish layer; and
a composite structure according to claim 1,
wherein the mortar layer is used between the extruded polystyrene layer and the leveling screed.

46. The system according to claim 45, wherein the primer composition is applied on both surfaces of the insulation layer.

47.-52. (canceled)
